(19) United States
(12) Patent Application Publication
(10) Pub. No.: US 2010/0132750 A1
(43) Pub. Date: Jun. 3, 2010

(54) REVERSE OSMOSIS WITH TEMPERATURE CONTROL

(76) Inventors: Karl Hildenbrand, Oberkirch (DE); Vera Schneider, Offenburg (DE)

Correspondence Address: Muncy, Geissler, Olds & Lowe, PLLC, 4000 Legato Road, Suite 310, FAIRFAX, VA, 22033, US

(21) Appl. No.: 12/626,600

(22) Filed: Nov. 25, 2009

Related U.S. Application Data
(63) Continuation of application No. PCT/EP2008/001971, filed on Mar. 12, 2008.

(30) Foreign Application Priority Data
May 25, 2007 (DE) 10 2007 024 424.1

(51) Int. Cl. A47L 15/42; B08B 3/02; B08B 3/10

(52) U.S. Cl. 134/56 D; 134/103.2; 134/103.1

(57) ABSTRACT

A water treatment device is provided, which has a reverse osmosis device with a raw water supply line, with a pure water discharge line and with a concentrate outflow. The raw water supply line is connected to a mixing device which is designed to set the mixing temperature of the raw water delivered to the reverse osmosis device. The mixing device has a hot water inflow and a cold water inflow.

This nonprovisional application is a continuation of International Application No. PCT/EP2008/001971, which was filed on Mar. 12, 2008, and which claims priority to German Patent Application No. DE 10 2007 024 424.1, which was filed in Germany on May 25, 2007, and which are both herein incorporated by reference

### BACKGROUND OF THE INVENTION

1. Field of the Invention

The invention relates to a water treatment device and to a dishwasher which comprises a water treatment device of this type. Furthermore, the invention relates to a method for the operation of a reverse osmosis device and of a dishwasher having a reverse osmosis device.

2. Description of the Background Art

In many fields of technology, liquids which should have a minimum degree of purity must be supplied to a process or a consumer. An important example of this is the field of washing machines and dishwashers which are used for cleaning various types of washing stock. In particular, but not exclusively, this washing stock may be hereafter dishes, glasses, cutlery, trays or the like.

Particularly in the field of industrial dishwashers, the water quality of the water supplied is of considerable importance. Inadequate water quality leads to complicated additional measures having to be taken in order to ensure a sufficient cleaning capacity. For example, this may involve the addition of chemical substances which, for example, cause rinsing with a satisfactory result. However, additives of this type, because of the high liquid quantities occurring overall, cause serious pollution for the environment and considerably increase the operating costs of industrial or commercial dishwashers of this type. In the domestic sector, too, the disadvantages mentioned. have a noticeable effect. In particular, the environmental pollution in this case plays a major part on account of the large number of dishwashers existing in private households.

One possibility for operating dishwashers of this type or else other consumers is to treat supplied water prior to supply. A plurality of such systems and methods for water treatment are known from the prior art. In addition to filters and ion exchangers, it is known, for example, to use reverse osmosis, as it is known, for water treatment.

Reverse osmosis is a physical/chemical method for the purification of liquids or for the upgrading of substances dissolved in liquids. Reverse osmosis is used for the treatment of drinking and process water and in various other fields of technology.

In reverse osmosis, often also abbreviated to RO, pressurized raw water is supplied to an osmosis device. The pressure is in this case utilized in order to reverse the natural osmosis process by means of a semipermeable membrane. The medium in which the concentration of a specific substance, in particular of a specific impurity, is to be reduced is separated by the semipermeable membrane from the medium in which the concentration of the substance is to be increased. The latter medium is exposed to a pressure which must be higher than the osmotic pressure.

The osmotic membrane is set up in order to admit only the carrier liquid (solvent), for example water, and to retain the dissolved substances (solute). In contrast to conventional filters, as a rule, osmosis membranes do not have continuous pores, but, instead, the ions and molecules travel through the membrane material by virtue of diffusion processes.

The osmotic pressure rises with a growing concentration difference. When the osmotic pressure becomes equal to the applied pressure, an equilibrium is established, and a purification process no longer takes place. Correspondingly, as a rule, the concentrate is discharged continuously.

A reverse osmosis device has, as a rule, one or more membranes and also one or more pressure increasing pumps and various control and regulating members. The semipermeable membrane is in this case, in many instances, designed as a wound module or hollow fiber module, other embodiments also being known and being capable of being used for the present invention. The pure water (permeate) pressed through the semipermeable membrane is supplied to a consumer, degrees of purity of up to approximately 98% being possible. The water (concentrate) upgraded with impurities, such as, for example, salts, minerals, suspended substances, etc., is usually delivered to an outflow.

In dishwasher technology, the pure water is utilized so that, for example, the dishes or other types of washing stock washed with detergent solution can dry off, without visible residues (water spots), after rinsing with fresh water is concluded. In many instances, a reverse osmosis device precedes the dishwasher as an independent unit, or the reverse osmosis device may be installed as a unit integrated into the dishwasher.

When a reverse osmosis device is used, an essential aim is to have an optimal ratio of pure water to concentrate, so that the water consumption and consequently the operating and water costs are minimized. Depending on circumstances, the concentrate fraction may lie above 50%. The ratio of pure water to concentrate is dependent on various factors, for example the type of construction of the reverse osmosis device, the components used, the raw water quality, the water pretreatment (for example, prefiltration for dirt, hardeners, chlorine, iron, manganese, potassium permanganate, silicic acid, etc.), the expected useful life of the membrane and the desired degree of purity of the pure water (for example, the residual conductance).

In many instances, in known systems using a reverse osmosis device, the operating costs and the water consumption are outside the acceptable limits which are set for domestic appliances and/or commercial dishwashers. A further disadvantage of known systems is that the ratio of pure water to concentrate may sometimes undergo pronounced fluctuations, and therefore the operating costs are also not always constant and therefore cannot always be predicted. The water quality of the pure water is also sometimes subject to pronounced fluctuations.

### SUMMARY OF THE INVENTION

It is therefore an object of the present invention to provide a water treatment device, in particular for use in a dishwasher, which lowers the operating and water costs and which improves the water quality and treatment yield.

In an embodiment, it is recognized that the temperature of the inflowing water (raw water) has a considerable influence on the pure water yield. However, the temperature of the inflowing water may differ regionally or, for example, may fluctuate according to the seasons and climatic conditions. In this case, as a rule, the pure water quantity rises with a rising temperature and with a concentrate water quantity which remains the same.

Even if the temperature of the raw water supplied lies within the values stipulated by the module manufacturers of the reverse osmosis devices (typically 1 to 30° C. or 1 to 45° C., higher values are possible), the pure water quantity is subject to pronounced fluctuations. Thus, the pure water quantity rises with a rising temperature and with a concentrate water quantity which remains at least approximately the same. The difference between the lowest and the highest possible inflow temperatures of those mentioned may amount to many times the pure water quantity.

On the basis of this recognition, the idea according to the invention is essentially to feed the reverse osmosis device with raw water having a stipulated and preferably exactly regulated or set temperature. This stipulated temperature can be adapted to the conditions of the reverse osmosis device and of a connected consumer and to the water inflow temperatures.

A water treatment device is correspondingly proposed which has a reverse osmosis device with a raw water supply line, with a pure water discharge line and with a concentrate water outflow. The raw water supply line is in this case connected to a mixing device which has a hot water inflow and a cold water inflow and also preferably a temperature sensor for measuring a mixing temperature of the mixed water supplied to the reverse osmosis device. By means of this device, the stipulated temperature of the raw water supplied to the reverse osmosis device can be set by the mixing of cold water with hot water.

The reverse osmosis devices used may in this case be commercially available reverse osmosis devices which are obtainable commercially. In this case, essentially, all current types and forms of semipermeable membranes, for example the types and forms described above, can be employed.

In particular, the mixing device for setting the water temperature of the raw water may have a mixing valve for the mixing of hot water and cold water. Alternatively or additionally, the hot water inflow and/or the cold water inflow may also have in each case at least one of the following elements: a valve, in particular a solenoid valve; a temperature sensor, a temperature controller, a throttle, in particular a throttle with a permanently set or settable throttle cross section. Thus, mixing temperatures for the raw water supplied to the reverse osmosis device can likewise be set.

Furthermore, the water treatment device may alternatively or additionally be configured in such a way that the mixing device has a mixing container into which preferably the hot water inflow and the cold water inflow issue. This mixing container is then connected to the reverse osmosis device. Thus, for example, the desired temperature can initially be set in the mixing container, for example, again, with the aid of temperature sensors and/or temperature controllers. To generate the pressure necessary for reverse osmosis, the mixing container may be connected to the reverse osmosis device via a pressure increasing pump.

Furthermore, the water treatment device may additionally comprise a regulating device. In addition to the temperature control device already mentioned, this regulating device may also comprise further functions, such as, for example, “intelligent” control in which further control parameters (for example, the water quality of the raw water/pure water, desired water quality, cold water temperature, etc.) are taken into account. The regulating device may comprise, for example, a microprocessor or another computer, in which specific control algorithms are stored, and also input and output devices. Alternatively or additionally, the regulating device may also comprise a simple electronic regulation based on discrete electronic modules.

The pure water yield and/or the water quality may be further improved, in that part of the concentrate is recirculated. Accordingly, the concentrate outflow may be connected to the raw water inflow via a concentrate recirculation. The recirculation ratio may be set, for example, via permanently set or settable (for example, also electronically settable or regulatable) diaphragms in the concentrate recirculation and/or in the concentrate outflow.

The proposed water treatment device in one of the versions described above has, as compared with conventional water treatment devices, numerous advantages which are reflected particularly in commercial use. Thus, the efficiency and the capacity of the water treatment device having a temperature-controlled raw water supply are higher, since the concentrate water quantity can be lowered in relation to the pure water fraction. In particular, the water consumption and the operating costs are thereby lowered considerably. Furthermore, the operational readiness of a system, for example of a water treatment device having a consumer connected to it, can be greatly accelerated, or the duration until operational readiness arises can be lowered or can be made more predictable in comparison with conventional systems. In particular, for example, dishwashers or other consumers requiring pure water can be filled more quickly or put into operational readiness more quickly.

Furthermore, owing to the reduced durations, cycle times and/or working times of the water treatment device or of the finished systems can also be lowered. Moreover, the operating and labor costs can be reduced, and the overall water treatment method can be made more environmentally friendly. Also, owing to the increase in efficiency of water treatment, smaller reverse osmosis devices can be used, thus lowering the procurement costs and reducing the space requirement at the workstation and the overall size of the systems.

A further advantage of the temperature-controlled raw water supply to the reverse osmosis device is that the pressure in the reverse osmosis system is highly dependent on the temperature of the raw water supplied. The system pressure may be many times higher at low temperatures than at raised temperatures. Thus, here too, the constantly higher temperature has considerable advantages. In particular, the safety of the components used for the water treatment device is increased or ensured (that is to say, for example, the safety of the overall module, of a pump, of a control and regulating unit, of connecting lines, etc.). As a result, not only does user friendliness rise, but also the useful life of the components is increased. Furthermore, owing to the lowering of pressure, the risk of leaks (for example, water damage) and of hazards to persons is greatly reduced.

The temperature of the raw water supply in this case preferably lies close to the maximum temperature of the reverse osmosis device, that is to say, for example, 10% or 5% (in ° C.) below this maximum temperature. In this case, if appropriate, a tolerance of the preceding temperature control must be taken into account, so that the maximum temperature tolerance, together with the desired temperature, does not overshoot the maximum temperature of the reverse osmosis device or of the osmosis. module.

Furthermore, reverse osmosis modules are also known which can be operated at 60° C. (up to 90° C.). In modules of this type, the limit of the inflow water temperature may be dependent on the site conditions.

A natural limit of the temperature of the raw water supply may, in particular, lie, for example, in the region of approximately 60° C. At relatively high temperatures, in the case of lime-containing water, lime precipitations may occur, which may lead to operating faults of the reverse osmosis device and/or of preceding components or even of the overall water treatment device.

As mentioned above, the water treatment device can be used particularly advantageously within the framework of a dishwasher. In this context, as described above, the term “dishwasher” is to be interpreted broadly and embraces a multiplicity of possible types of washing stock. It may in this case be a single-chamber or a multichamber dishwasher, even continuous-flow dishwashers benefitting greatly from the idea according to the invention. Particularly in the commercial sector, the advantages described above are in this case highly noticeable.

The dishwasher comprises a washing chamber with a spray system for subjecting washing stock to washing liquid. This spray system may, for example, contain a spray system for a washing operation with a first washing liquid, which system is used, for example, for circulating operation. Furthermore, this spray system may comprise a rinsing spray system which is particularly preferably operated with pure water. The proposed dishwasher is equipped with a washing liquid inflow which is connected to a water treatment device according to one of the embodiments described above. Thus, pure water can be supplied to the washing liquid inflow from the pure water discharge line of the reverse osmosis device, and use can be made of this particularly for a rinsing operation. However, the pure water may also be used for other washing operations, for example for filling a circulation tank at the commencement of a washing cycle.

In a particularly preferred method for operating the device or the dishwasher, waste heat from the dishwasher is utilized for the temperature control of the raw water delivered for reverse osmosis. Quite apart from the dishwasher described, this basic idea may be transferred to any other type of consumer which has any (wanted or unwanted) heat source and is fed with pure water. In this case, the hot water used for mixing by the mixing device can be generated or heated by utilizing the waste heat from the consumer for this purpose via a heat exchanger. This heat exchanger (which may accordingly also be a plurality of heat exchangers) can be adapted to the circumstances of the consumer.

In the case of the dishwasher, for example, the dishwasher may have a heating device for heating the washing liquid supplied. For example, this heating device may comprise a boiler which may be utilized, in particular, in order to heat up rinsing liquid. Particularly preferred temperatures in the region of this boiler or the washing liquid in the boiler lie between 60° C. and 85° C. The heating of the boiler may take place, for example, electrically, via steam, via hot water, via gas or via other known heating devices. The term “boiler” is in this context to be interpreted broadly and may also embrace, for example, a flow heater. The boiler may be directly connected, for example, to the spray system, in that, for example, a pressure of the pure water supplied to the boiler is utilized. Alternatively or additionally, the boiler may also be connected to the spray system via a pressure increasing pump.

To implement the above-described idea of heating the hot water for the mixing device by means of waste heat from the dishwasher, the boiler may, for example, additionally have a boiler heat exchanger. In this case, for example, cold water can be supplied to the heat exchanger and then be heated in the heat exchanger, so as then to be supplied to the mixing device in order to generate the temperature-controlled raw water for the reverse osmosis device.

Alternatively or additionally to the described possibility of utilizing the waste heat for generating hot water by use of a boiler heat exchanger, the dishwasher may also comprise a tank in which the washing liquid is at least partially collected. For example, this tank may be a circulation tank. The tank may also be designed to be heatable or temperature-controllable (for example, by means of a corresponding heating and/or regulating device), for example in order to keep the liquid in the tank at a preferred temperature of 60° C. to 75° C.

This tank, too, may have a tank heat exchanger which is connected to the hot water inflow of the reverse osmosis device, so that the tank heat exchanger can heat the water supplied to the hot water inflow.

Other types of utilization of waste heat for heating the hot water for the reverse osmosis device may also be envisaged. Thus, alternatively or additionally to the possibilities described above, the dishwasher may have, furthermore, a heat recirculation heat exchanger which is connected to the hot water inflow of the reverse osmosis device and which can heat the water supplied to the hot water inflow.

In particular, this heat recirculation heat exchanger may be configured in such a way that it utilizes hot air and/or steam in the washing chamber or the heat contained therein. In particular, the heat recirculation heat exchanger may have, for this purpose, a condensate precipitation device, on which the steam contained in the washing chamber condenses and at the same time discharges heat to water in the heat recirculation heat exchanger. For example, this condensate precipitation device may be one or more cooling plates, cooling coils, etc. The liquid to be heated may flow through these. Alternatively or additionally, the condensate which condenses on these cooling elements and still has a raised temperature may also be utilized. The cooling coils or cooling plates may also be arranged, for example, in a housing through which the steam or the hot air flows, for example driven by a blower. The heat recirculation heat exchanger may also be connected, in turn, to a cold water inflow and, on the outflow side, to the hot water inflow of the reverse osmosis device.

The water treatment device may in this case be integrated into a housing of the dishwasher or may also be designed completely or partially as a separate unit separated from the rest of the dishwasher. It is particularly preferable in this case if the dishwasher has a machine control which is set up in order to control the mixing device of the water treatment device. For example, this machine control may comprise a program control for the control of program sequences of the dishwasher, the operation of the water treatment device being controlled simultaneously or additionally. For example, this water treatment device may be controlled in such a way that it is synchronized in time with the pure water demand in the dishwasher, so that, for example, pure water is provided in due time in a boiler, without remaining there for too long a time. The program sequences can thereby be optimized. For example, this machine control may, in turn, comprise one or more computers, for example a microcomputer which is correspondingly set up in programming terms for the control. Furthermore, input and output devices, for example one or more displays, a keyboard or the like, may correspondingly be contained. Alternatively or additionally, the machine control may also comprise corresponding electrical control modules.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a water treatment device which is connected to a consumer;

FIGS. 2 and 3 show a permeate flow through a reverse osmosis device and the pressure on a raw water supply line of a reverse osmosis device as a function of the water temperature; and

FIG. 4 shows an exemplary embodiment of a dishwasher according to the invention with a water treatment device.

### DETAILED DESCRIPTION

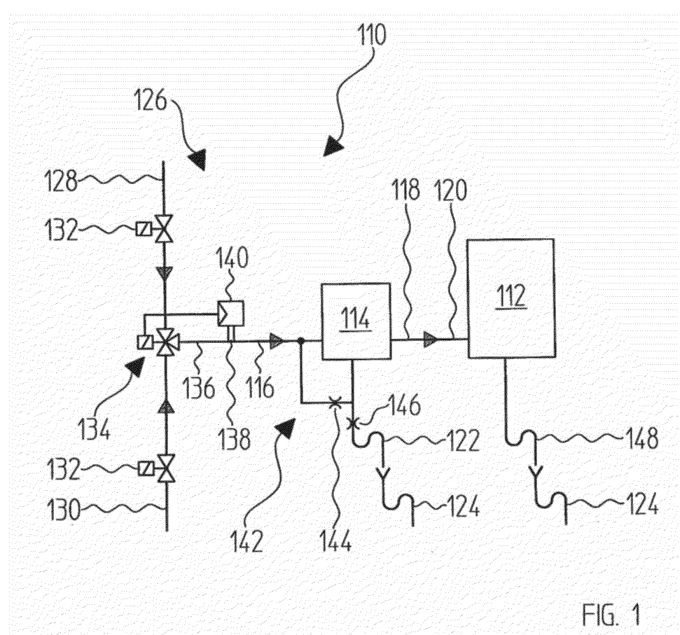

FIG. 1 illustrates an exemplary embodiment of a water treatment device 110 which is connected to a consumer 112. The central element of this water treatment device 110 is a reverse osmosis device 114 which may be, for example, a commercially obtainable reverse osmosis device with a membrane, for example a polyamide membrane. As described above, in this case various embodiments known to a person skilled in the art are possible.

The reverse osmosis device 114 has a raw water supply line 116 and a pure water discharge line 118. The pure water discharge line is connected to a pure water inflow 120 of the consumer 112. Furthermore, the reverse osmosis device 114 has a concentrate outflow 122 which, for example, may be connected to an outflow 124.

The water treatment device 110 comprises, furthermore, a mixing device 126. The mixing device 126 has a hot water inflow 128 and a cold water inflow 130. Preferably, the cold water inflow 130 is subjected to cold water having a temperature of between 10° C. and 30° C., whereas the hot water inflow 128 is preferably subjected to hot water having a temperature of 40° C. to 60° C. The inflows 128, 130 may be connected, for example, to corresponding hot and cold water supplies which are provided, for example, by means of house lines or by means of additional supply devices. The cold and hot water inflows 130 and 128 have in each case inflow valves 132, which, for example, may be solenoid valves.

In the exemplary embodiment illustrated in FIG. 1, the cold and hot water inflows 130 and 128 issue in a mixing valve 134. This mixing valve is connected at its mixing outlet 136 to the raw water supply line 116.

The temperature of the mixed water provided by the mixing outlet 136 to the raw water supply line 116 is monitored by a temperature sensor 138. This temperature sensor is connected to a regulating device 140 which, in turn, acts on the mixing valve 134 in order to permanently set or to regulate the temperature of the raw water. For this purpose, the regulating device 140 can set or regulate, in particular, the ratio of hot water provided from the hot water inflow 128 to the cold water provided from the cold water inflow 130. Thus, the temperature of the raw water and consequently, as described above, the capacity of the reverse osmosis device 114 can be set exactly.

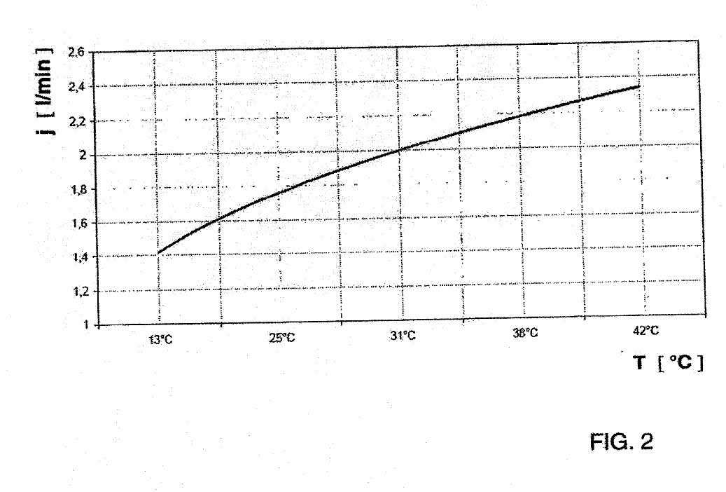

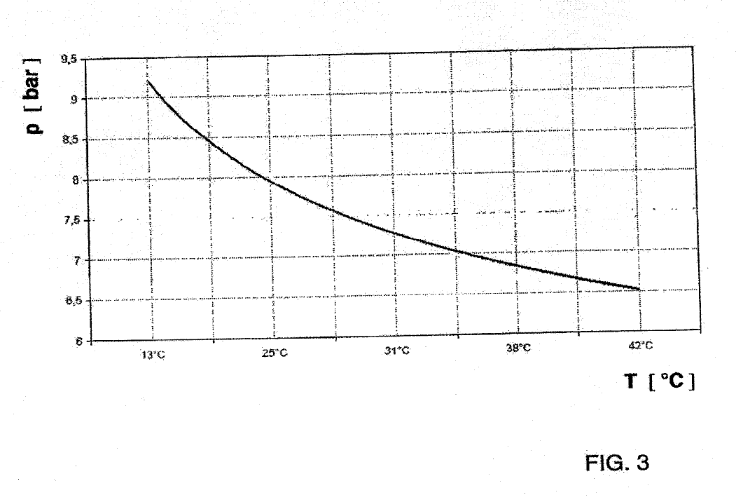

The effect of this temperature regulation or temperature setting of the raw water which is supplied to the reverse osmosis device 114 is illustrated in FIG. 2 and FIG. 3. There, the permeate throughflow j in l/min (FIG. 2) and the pressure p in bar (FIG. 3) on the raw water supply line 116 and the housing inlet of the reverse osmosis device 114 are in each case illustrated as a function of the temperature in ° C. over a range of between 13° C. and 42° C. This exemplary illustration constitutes merely an excerpt from a complete graph. For measurement, a commercially obtainable reverse osmosis plant with a preceding pressure increasing pump (not illustrated in FIG. 1) was used. Furthermore, concentrate recirculation was employed for this measurement. In this case, part of the concentrate was recirculated from the concentrate outflow 122 via a concentrate recirculation 142 to the raw water supply line 116. The concentrate recirculation ratio was set by means of two diaphragms 144 and 146.

As may be gathered from FIGS. 2 and 3, the permeate throughflow and the pressure at the housing inlet are greatly dependent on the raw water temperature. Thus, it is shown that, over the temperature range observed, the permeate throughflow rises by 64%. At the same time, the pressure at the housing inlet falls (and therefore, for example, also the risk presented by a water treatment device 110 of this type and the risk of a leak). The measurements show clearly that the efficiency of the water treatment device 110 and operating reliability can be markedly improved by regulating the temperature of the raw water supply according to the device illustrated in FIG. 1. If, instead of a simple setting of the raw water temperature, a regulation of this is carried out, as is likewise possible by means of the device according to FIG. 1, then, moreover, the reliability and reproducibility of water treatment can be improved considerably.

As already partially described above, numerous alternative embodiments of the watertreatment device 110 may be envisaged. Thus, alternatively to the raw water supply line illustrated here, via the mixing valve 134, a supply line to the osmosis unit via two individual valves may also take place. The mixing temperature can be set or regulated via a regulation of these two individual valves. Instead of valves, permanently set or regulatable throttles can also be used. Once again, temperature controls or temperature sensors can also be employed.

A further alternative to the mixing valve 134 illustrated in FIG. 1 is to use a mixing container. The inflows 128, 130 can issue into this mixing container, and the temperature in the mixing container can once again be set, for example, via valves in the inflows 128, 130, for example, again, via the inflow valves 132. Regulation may take place again via temperature controls or temperature sensors which are coupled to the mixing container. Once more, this mixing container can then be connected to the raw water supply line 116 of the reverse osmosis device 114 via the supply line pressure and/or by one or more pressure increasing pumps being interposed.

FIG. 1 illustrates a consumer 112 which is supplied with pure water by the reverse osmosis device 114 via the pure water inflow 120. The consumer 112 may be any desired consumer which requires water having a preferred minimum quality. The consumer 112 has a consumer outflow 148 which once again issues, for example, in an outflow 124.

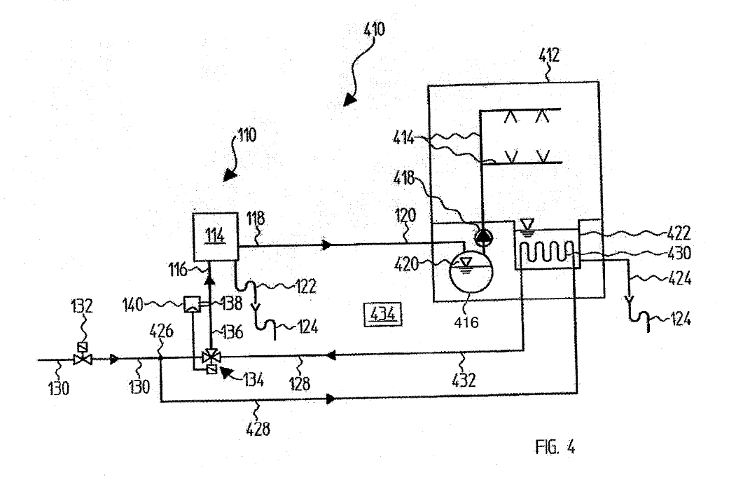

As described above, the water treatment device 110 illustrated in FIG. 1 can, in one of the alternatives described, be employed particularly advantageously for operating a dishwasher. A dishwasher 410 of this type is illustrated in an exemplary embodiment in FIG. 4.

The dishwasher 410 comprises a washing chamber 412 for the reception of washing stock (not illustrated). In the washing chamber 412, one or more spray systems 414 are provided, via which the washing stock can be subjected to washing liquid or rinsing liquid. In the exemplary embodiment illustrated in FIG. 4, the spray system 414 is configured solely as a rinsing spray system, spray systems also present, if appropriate, not being illustrated.

Furthermore, the dishwasher 410 has, within the washing chamber 412 in this exemplary embodiment, a boiler 416 which can be filled via a pure water inflow 120 (configured in FIG. 4 as a pressureless inflow). The boiler 416 is configured with a heating device (not illustrated in FIG. 4) in order to heat washing liquid in the boiler 416 to a desired boiler temperature (for example, between 60° C. and 85° C.). The washing liquid in the boiler 416 is then supplied to the spray system 414 via a pressure increasing pump 418. Furthermore, a level control 420 is provided in the boiler 416. Moreover, temperature sensors (not illustrated) may be arranged in the boiler 416.

Alternatively to using a pressure increasing pump 418, a supply line pressure of the pure water supply line 120 may also be utilized in order to supply the washing liquid (for example, rinsing liquid) to the spray system 414. In this case, the pressure increasing pump 418 may be dispensed with.

Furthermore, the dishwasher 410 has a tank 422 in the washing chamber 412. In this tank 422, which, for example, may also at the same time be a circulation tank for the washing operation (usually preceding the rinsing step), washing liquid is collected from the washing chamber 412. The tank 422 is connected to an outflow 124 via a tank outflow 424. The tank 422 may additionally have a tank heating (not illustrated). The tank temperature preferably lies between 60° C. and 75° C.

In an exemplary embodiment according to FIG. 4, the water treatment device 110 is constructed in a basically similar way to the example according to FIG. 1. The alternatives described above may also be implemented again accordingly.

Once again, a mixing valve 134 is used for a temperature-controlled supply of raw water to the reverse osmosis device 114. A particular feature of the dishwasher 410 illustrated in FIG. 4, however, is that the hot water inflow 128 leading to the mixing valve 134 is not connected to a hot water supply (to be provided, for example, on the building side). Instead, a line 428 leading to a tank heat exchanger 430 branches off from the cold water inflow 130 at a branch 426.

This tank heat exchanger 430 constitutes only one of several possible exemplary embodiments described above, whereby waste heat from the dishwasher 410 can be utilized in order to supply temperature-controlled raw water to the reverse osmosis device 114. The tank heat exchanger 430 may, for example, be placed in the tank 422, as illustrated in FIG. 4. Alternatively or additionally, it may also be arranged on the tank 422, it may be arranged in or on the boiler 416 or it may be arranged elsewhere in the washing chamber 412. For example, in the washing chamber 412, for example in the ceiling region, an arrangement of one or more heat exchanger plates may be provided, via which heat can be absorbed from the steam or hot air present in the washing chamber 412 after or during the washing operation. In particular, in this case, at least part of the steam present in the washing chamber 412 may also be condensed, thus affording the advantage, furthermore, that a pollution of the ambient air of the dishwasher 410 with steam vapors is reduced.

A line 432, which is to be equated with the hot water inflow 128, leads from the tank heat exchanger 430 to the mixing valve 134. In order further to set the ratio between cold water and hot water in the mixing valve 134, additional valves 132, for example, once again, solenoid valves, may also be provided between the branch 426 and the mixing valve 134 and/or in the lines 428 and/or 432.

Thus, once again, via the temperature controller 140, the temperature of the raw water supplied to the reverse osmosis device 114 can be set exactly, or this temperature regulated, at least in specific operating phases of the dishwasher 410. For example, in a circulation phase (washing), the waste heat from the washing water or the washing liquid may be utilized in order to supply exactly temperature-controlled raw water to the reverse osmosis device. 114, so as thereby, once again, to generate pure water for subsequent rinsing operation which is supplied to the boiler 416. Once again, the alternative refinements and modifications discussed above may also be envisaged, for example a partial recirculation of concentrate from the concentrate outflow 122 to the raw water supply line 116, said partial recirculation not being illustrated in FIG. 4, also being possible.

Furthermore, in the exemplary embodiment according to FIG. 4, the dishwasher 410 has a machine control 434. This machine control 434 may, for example, be connected to sensors, such as, for example, the temperature sensor 138, the level sensor 420 and/or further sensors and/or tracers. This machine control 434 may also completely or partially comprise the regulating device 140. This machine control 434 may, in particular, be configured in such a way that all operations and processes of the dishwasher 410 can be regulated by means of this machine control 434. In particular, the above-described regulation of the raw water temperature can be carried out by means of this machine control 434.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A dishwasher comprising:
a washing chamber with a spray system for subjecting washing stock to washing liquid;
a washing liquid inflow;
a water treatment device comprising: a reverse osmosis device with a raw water supply line; a pure water discharge line; a concentrate outflow, the raw water supply line being connectable to a mixing device, the mixing device being configured to set a mixing temperature of the raw water delivered to the reverse osmosis device; and a hot water inflow and a cold water inflow, the washing liquid inflow being connectable to the pure water discharge line of the reverse osmosis device,
a heating device configured to heat the washing liquid being supplied, the heating device comprising a boiler having a boiler heat exchanger that is connectable to the hot water inflow of the reverse osmosis device such that the boiler heat exchanger is configured to heat water supplied to the hot water inflow; and
a tank configured to partially collect the washing liquid, the tank having a tank heat exchanger that is connectable to the hot water inflow of the reverse osmosis device such that the tank heat exchanger is configured to heat water supplied to the hot water inflow.

2. The dishwasher as claimed in claim 1, wherein the mixing device has a mixing valve configured to mix hot water and cold water.

3. The dishwasher as claimed in claim 1, wherein the hot water inflow and the cold water inflow have at least one of the following elements:
a valve or a solenoid valve;
a temperature sensor;
a temperature controller; and/or
a throttle or a throttle with a permanently set or settable throttle cross section.

4. The dishwasher as claimed in claim 1, wherein the mixing device has a mixing container, the mixing container being connectable to the reverse osmosis device.

5. The dishwasher as claimed in claim 4, wherein the mixing container is connectable to the reverse osmosis device via a pressure increasing pump.

6. The dishwasher as claimed in claim 1, wherein the mixing device further comprises a regulating device configured to regulate the mixing temperature.

7. The dishwasher as claimed in claim 1, wherein the concentrate outflow is connectable to the raw water supply line via a concentrate recirculation such that part of the concentrate is recirculated.

8. The dishwasher as claimed in claim 7, wherein a recirculation ratio is settable via one or more diaphragms.

9. The dishwasher as claimed in claim 1, wherein the boiler is connectable to the spray system via a pressure increasing pump.

10. The dishwasher as claimed in claim 1, further comprising a heat recirculation heat exchanger that is connectable to the hot water inflow of the reverse osmosis device such that the heat recirculation heat exchanger is configured to heat water supplied to the hot water inflow.

11. The dishwasher as claimed in claim 10, wherein the heat recirculation heat exchanger has a condensate precipitation device for a recovery of heat from air contained in the washing chamber or from steam contained in the washing chamber.

12. The dishwasher as claimed in claim 1, further comprising a machine control, the machine control being configured to control the mixing device of the water treatment device.
